(19) United States
(12) Patent Application Publication
(10) Pub. No.: US 2008/0257582 A1
(43) Pub. Date: Oct. 23, 2008

(54) Sleeve For an Electrical Cable

(75) Inventors: Jean-Pierre Barriuso, Bosc Roger Sur Buchy (FR); Patrick Hauchard, Maromme (FR); Simon Pizzo, Reze (FR)

Correspondence Address: YOUNG & THOMPSON, 209 Madison Street, Suite 500, ALEXANDRIA, VA, 22314, US

(73) Assignees: LEGRAND FRANCE, Limoges (FR); LEGRAND SNC, Limoges (FR)

(21) Appl. No.: 12/089,205

(22) PCT Filed: Oct. 2, 2006
(86) PCT No.: PCT/FR2006/002217

§ 371 Date: Jun. 5, 2008

(30) Foreign Application Priority Data
Oct. 4, 2005 (FR) 0510124

(51) Int. Cl. H01B 17/00

(52) U.S. Cl. 174/137 R

(57) ABSTRACT

The sleeve for an electric cable comprises two bodies (2, 3) and a hinge (4). Each body (2, 3) is flexible in the profile thereof, has, in the absence of mechanical stress, a position of rest in which it is curved whereas it is designed for being bent from the position of rest. The sleeve has an open position in which the bodies (2, 3) are separated from one another when in the position of rest, has a first stable closed position in which a first body (3) receives the second body (2) and has a second stable closed position in which the second body (2) receives the first body (3). The sleeve is designed for being deformed by folding the hinge (4) and to flex in the profile of these bodies (2, 3) in order to pass from the open position into one or other said stable closed positions.

### FIELD OF THE INVENTION

The present invention concerns a sleeve for an electrical cable.

### TECHNOLOGICAL BACKGROUND

Sleeves are frequently employed in electrical installations, when they are made from insulative material, to isolate an electrical component from the external environment in order in particular to protect the user from direct electrical contact with the component, for example an electrical cable and/or a tag for a connecting terminal crimped to the end of the cable.

There are known already, in particular from French patent 2 841 048, insulative sleeves for tags including two rigid trough-shaped shells each connected longitudinally by a hinge to a rigid body and both mobile between an open position in which they are moved away from each other and a closed position in which the free edges of the shells are one against the other, the sleeve then having a globally circular cross section. The body has also a ring for clipping it onto the tag while the troughs feature mutual fixing means to hold them edge-to-edge in the closed position around the tag.

The invention aims to offer a simple and economical sleeve that offers good performance, in particular where its mode of fixing to the electrical cable is concerned.

To this end it proposes a sleeve for electrical cables, including two troughs and a hinge; characterized in that each of said troughs is flexible in profile, extends from a first longitudinal edge attached to said hinge to a free second longitudinal edge, assumes in the absence of mechanical loading a relaxed position in which it is curved with said first longitudinal edge at a distance from the second longitudinal edge whilst it is adapted to be flexed from said relaxed position in the direction in which said distance varies; said sleeve assuming an open position in which said troughs are away from each other in the relaxed position, the concave surface of each of said troughs facing a space which is then empty, assuming a first stable closed position in which said space of a first of said troughs receives the second trough and assuming a second stable closed position in which said space of the second trough receives the first trough, said sleeve being adapted to be deformed by bending of said hinge and flexing in profile of said troughs to pass from said open position to one or the other of said stable closed positions, said first trough flexing with said distance that increases and then decreases to receive said second trough on passing from said open position to said first closed position, said second trough flexing with said distance that increases and then decreases to receive said first trough on passing from said open position to said second closed position.

Accordingly, to fit the sleeve according to the invention to an electrical cable, for which the sleeve has the appropriate dimensions, the cable is placed in the space facing the concave surface of either of the two troughs, after which that trough is placed in the other trough to close the sleeve.

Thus the sleeve is moved from its open position to one or the other of its stable closed positions quickly and easily.

The simple overall shape of the end-piece and its ability to receive the cable interchangeably in either of the troughs facilitates its manipulation and makes it intuitive for the user.

The partial overlapping of the troughs secures the sleeve around the cable in a particularly reliable way, and the sleeve of the invention is therefore particularly safe to use.

According to features preferred for the same reasons as stated hereinabove:
for each of said closed positions said troughs overlap over at least a quarter of the perimeter that said sleeve then has; and/or
in said open position, said troughs have conformations that are mirror images of each other; and/or
each of said troughs has a circular arc profile in said relaxed position subtending an angle between the first longitudinal edge and the second longitudinal edge greater than 180°; and/or
each of said troughs has in its relaxed position a circular arc profile of the same diameter over the whole of its length; or
each of said troughs has in its relaxed position a circular arc profile of regularly varying diameter over the whole of its length; and/or
each of said troughs features a succession of ribs; and where applicable
each of said troughs is formed by a corrugated wall the corrugations whereof form said ribs; and where applicable
said corrugations have a constant amplitude; or
said corrugations have a regularly varying amplitude; and/or
said hinge is an elongate flexible tongue; and where applicable
said tongue has parallel longitudinal edges; or
said tongue has longitudinal edges inclined toward each other; and/or
said flexible tongue is made from the same material as said troughs and has a thickness different to the thickness of said troughs; and where applicable
said thickness of said flexible tongue is smaller than the thickness of said troughs; and/or
said sleeve is made from an electrically insulative material; and where applicable
said material is a molded thermoplastic material; or
said material is a extruded thermoplastic material; and where applicable
said thermal plastic material is a polyamide; or
said thermal plastic material is a PVC.

### BRIEF DESCRIPTION OF THE DRAWINGS

The features and advantages of the invention will emerge from the following description of a preferred embodiment, given by way of nonlimiting illustration, with reference to the appended drawings, in which:

FIGS. 1 and 2 are two perspective views from different angles showing a first embodiment of an insulative sleeve according to the invention in its open position;

FIGS. 3 and 4 are respectively a view in elevation of this sleeve seen from the side that is the front in FIG. 2 and a plan view from above;

FIGS. 5 and 6 are views similar to FIGS. 2 and 3 but in which the sleeve is represented in one of its closed positions;

FIGS. 7 and 8 are views similar to FIGS. 5 and 6 but in which the sleeve is represented in the other of its closed positions;

FIG. 9 is a perspective view of an electrical cable with its end fitted with a connecting tag;

FIGS. 10 and 11 are two perspective views respectively showing how the insulative sleeve cooperates with this cable in its open position and in its closed position;

FIGS. 12 and 13 are two views similar to FIGS. 1 and 2 but illustrating a second embodiment of the insulative sleeve;

FIGS. 14 and 15 are respectively a view in elevation of this sleeve from the side seen at the rear in FIG. 13 and a plan view from above;

FIGS. 16 and 17 are two perspective views from two different angles showing how this sleeve cooperates with an electrical cable in its closed position;

FIG. 18 is a view similar to FIG. 15 but illustrating a third embodiment of the insulative sleeve; and

FIG. 19 is a part-sectional view to a larger scale of a wall of one of the troughs of a fourth embodiment of the sleeve.

### DETAILED DESCRIPTION OF PREFERRED EMBODIMENTS

In the preferred embodiments illustrated in the drawings, the sleeve is made from an insulative material for electrical isolation of the cable.

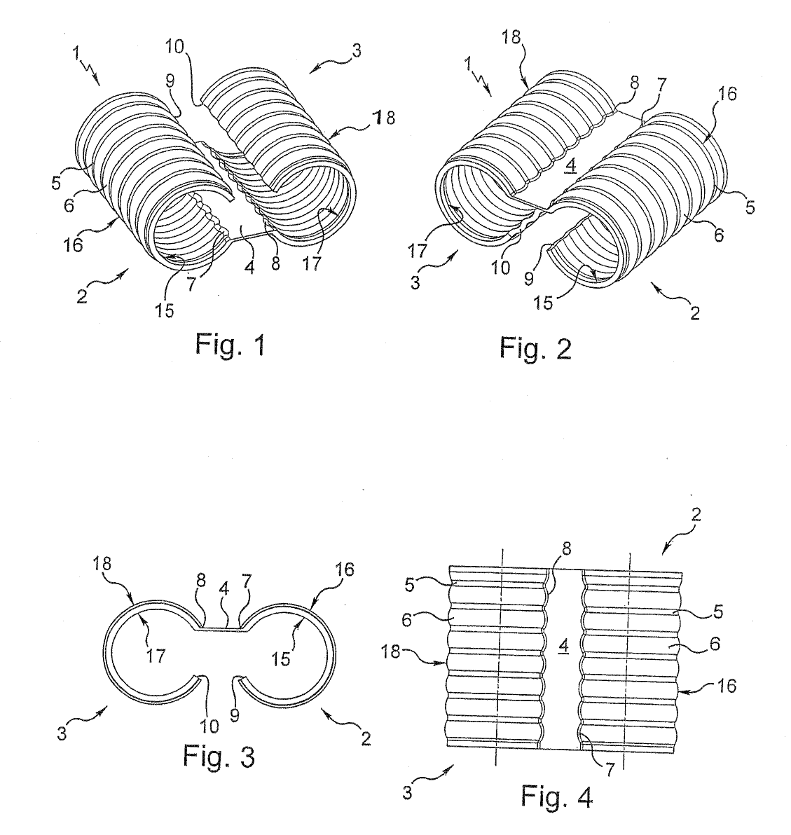

The sleeve 1 represented in FIGS. 1 to 8 comprises two troughs 2 and 3 and a hinge 4 between the two troughs.

Here the sleeve is made in one piece from an electrically insulative material, here a molded thermoplastic material from the polyamide family.

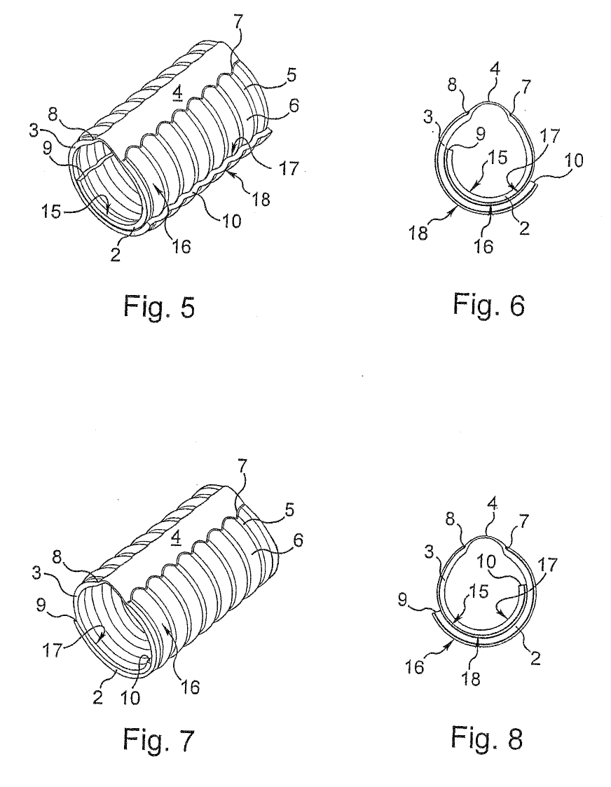

As will emerge hereinafter, the sleeve has an open position represented in FIGS. 1 to 4 in which the troughs are moved away from each other, a first stable closed position represented in FIGS. 5 and 6 in which the trough 2 is nested inside the trough 3, and a second stable closed position represented in FIGS. 7 and 8 similar to the first stable closed position but in which the trough 3 is nested inside the trough 2.

In FIGS. 1 to 4 the sleeve is represented in its open position, with the troughs 2 and 3 in a relaxed position with no mechanical loading.

In its relaxed position, the trough 2 has a circular arc profile. It extends from a first longitudinal edge 7 connected to the hinge 4 to a free second longitudinal edge 9 at a distance from the edge 7, this trough being delimited by a concave surface 15 inside the trough and a convex surface 16 outside the trough.

The trough 2 is of constant diameter over the whole of its length and subtends an angle between the free edge 9 and the connected edge 7 greater than 180°, approximately 315° in the example shown, imparting a C-shape to the trough 2.

The wall of the trough 2 is of constant thickness and corrugated with a constant amplitude over the whole of its length, each corrugation consisting of a hollow 5 and a boss 6. These corrugations form a succession of ribs that impart a ringed shape to the trough.

The trough 2 is flexible in profile, i.e. is adapted to be deformed in directions contained in planes transverse to the longitudinal direction of the sleeve to flex from its relaxed position in the direction in which the distance between the edge 7 and the edge 9 varies and to revert to its relaxed position when it is no longer subjected to mechanical loading.

The trough 3 is identical to the trough 2 except that its conformation is a mirror image of that of the trough 2 in the relaxed position. The trough 3 therefore extends from a first longitudinal edge 8 connected to the hinge 4 to a free second longitudinal edge 10 at a distance from the edge 8, this trough being delimited by a concave surface 17 inside the trough and a convex surface 18 outside the trough.

The hinge 4 is a flexible elongate tongue with parallel longitudinal edges and having a generally rectangular shape when the sleeve is in its open position.

The flexible tongue is made from the same material as the troughs 2 and 3 but is thinner than the troughs 2 and 3 (see FIG. 3) to obtain the required flexibility.

In the open position of the sleeve, the troughs 2 and 3 are away from each other and the concave surfaces 15 and 17 of the troughs face a space which is empty at this time and the flexible tongue 4 is in a flat position.

In the first closed position when empty (with no electrical component inside the sleeve), represented in FIGS. 5 and 6, the space of the trough 2 remains empty and the concave surface 17 of the trough 3 then envelops the convex surface 16 of the trough 2 so that the troughs overlap over at least a quarter of the perimeter of the sleeve in the first closed position. In the example shown, the troughs overlap over approximately one half-perimeter.

In the second closed position, when empty, represented in FIGS. 7 and 8, similar to the first closed position but with the troughs 2 and 3 interchanged, the space of the trough 3 remains empty and the concave surface 15 of the trough 2 then envelops the convex surface 18 of the trough 3 so that the troughs overlap over approximately one half-perimeter.

In both these closed positions the flexible tongue is bent.

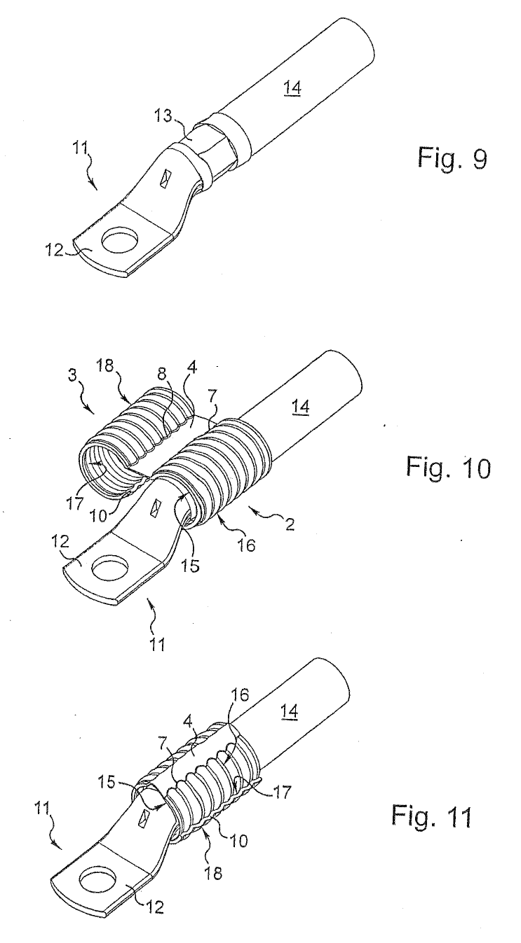

The tag 11 (FIG. 9) includes a flat portion 12 featuring a hole for the relevant portion of the connecting terminal to pass through and a tubular portion 13 in which the stripped end of an electrical cable 14 is received, the portion 13 being crimped onto this end portion by an intermediate section of hexagonal contour.

The operation of nesting the sleeve 1 around the tubular portion 13 of the tag 11 and the cable 14 is described next with the aid of FIGS. 10 and 11. In FIG. 11, the sleeve is represented turned slightly from the position that it occupies in FIG. 10 in order to make the flexible tongue 4 more clearly visible.

The first step consists in nesting the tag 11 and the cable 14 in one or the other of the troughs of the sleeve in the open position.

If the tag and the cable are nested in the trough 2, the second step then consists in moving the sleeve into its first stable closed position (FIGS. 5 and 6), whereas if the tag and the cable are nested in the trough 3, the second step then consists in moving the sleeve to its second stable closed position (FIGS. 7 and 8).

In the example shown the tag and the cable are nested in the trough 2.

To this end the operator presses the edges 7 and 9 of the trough 2 against the portion 13 of the tag 11 and the end portion of the cable 14. The trough 2 flexes and, because of this mechanical action, moves from its relaxed position to a working position in which the edges 7 and 9 of the trough 2 are spaced apart, the distance between them increasing, to allow the portion 13 of the tag 11 and the end portion of the cable 14 to pass between them in order for them to occupy the (initially empty) space situated inside the trough 2, facing the concave surface 15.

During this nesting operation, the edges 7 and 9, after being moved apart to allow the portion 13 of the tag and the end portion of the cable 14 to pass between them, move toward each other again (the distance between them decreases) because of the return spring effect of the wall of the trough 2, which then closes around the portion 13 of the tag 11 and the cable 14.

The second step consists in similarly nesting the trough 2 in the trough 3 to move the sleeve 1 into its first stable closed position.

To this end the operator brings the edge 10 of the trough 3 into contact with the convex surface 16 of the trough 2 in order to slide it along that surface. The smaller thickness of the tongue 4 provides flexibility enabling it to be deformed to bend and to form a hinge around which the trough 3 pivots relative to the trough 2. The pressure exerted by the operator on the trough 3 causes the trough 3 to move from its relaxed position to a working position in which the longitudinal edges 8 and 10 are spread apart, the distance them increasing, to allow the trough 2 to pass between them in order for it to occupy the (initially empty) space situated inside the trough 3 facing the concave surface 17.

During this nesting operation, the edges 8 and 10, after being moved apart to allow the trough 2 to pass between them, move toward each other again (the distance between them decreases) by virtue of the return spring effect of the trough 3, which then closes around the trough 2.

In this closed position, the concave surface 15 and part of the concave surface 17 face the tag 11 and the end portion of the cable 14. The other portion of the concave surface 17 faces the convex surface 16 of the trough 2.

During the operation of nesting the trough 2 in the trough 3, the hollows 5 of the trough 2 form slides inside which the hollows 5 of the trough 3 slide while the bosses 6 of the trough 3 form slides in which the bosses 6 of the trough 2 slide.

The identical dimensions of the troughs 2 and 3 when relaxed means that, when one of the troughs is nested inside the other, each trough exerts permanent mechanical stresses on the other. In the example shown, when the sleeve is in the first closed position, the wall of the trough 3 exerts a pressure against the wall of the trough 2 (because of the spring return forces generated by the nesting) holding the trough 2 around the tag and the cable in a stable manner.

The partial overlapping of the troughs reinforces the stable and permanent nesting and prevents accidental opening of the sleeve, for example on bending the cable 14.

The troughs of the sleeve also have flexibility in the longitudinal direction to espouse the shape of the cable when it is bent.

The operations of nesting the tag in the trough 3 and then of moving the sleeve into the second closed position are carried out in a similar way except that the troughs 2 and 3 are interchanged.

The operations of opening the sleeve 1 and then removing it from the tag 11 and the cable 14 are the opposite of the operations of nesting and closing the sleeve described hereinabove.

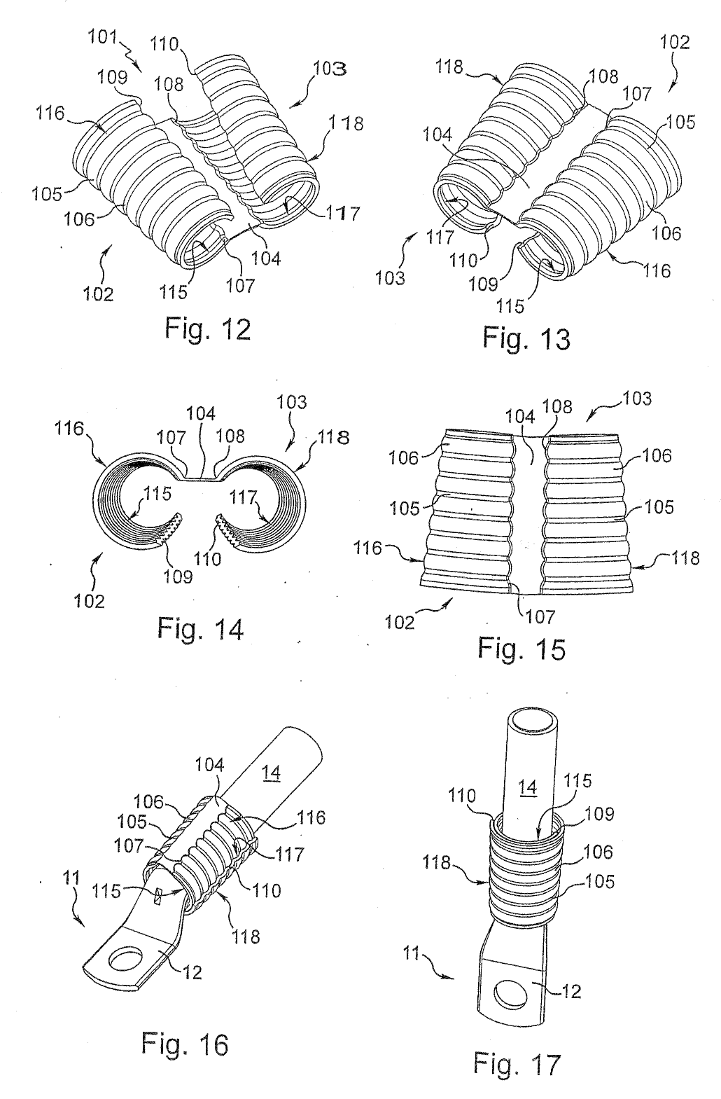

Another embodiment of the sleeve is represented in FIGS. 12 to 17. As a general rule, the same references have been used for similar elements, but increased by 100 for each embodiment.

The troughs 102 and 103 of this sleeve 101 each have over the whole of their length a circular arc profile subtending a globally constant angle approximately equal to 315° and a diameter that varies in a regular manner to form two troughs of frustoconical general shape in the example shown.

The walls of the troughs 102 and 103 are of constant thickness and corrugated with a constant amplitude over the whole of their length, each corrugation consisting of a hollow 105 and a boss 106.

The troughs 102 and 103 are connected by a flexible tongue 104 with parallel longitudinal edges.

The frustoconical shape of the troughs means that the sleeve can be removed from its mold simply and quickly without the bosses 106 catching on projecting portions of the mold during removal. The taper is determined as a function of the necessary slope for removal from the mold and as a function of the amplitude of the corrugations.

This sleeve cooperates with the cable 14 like the sleeve 1, the smallest diameter portions of the troughs being closest to the flat portion 12.

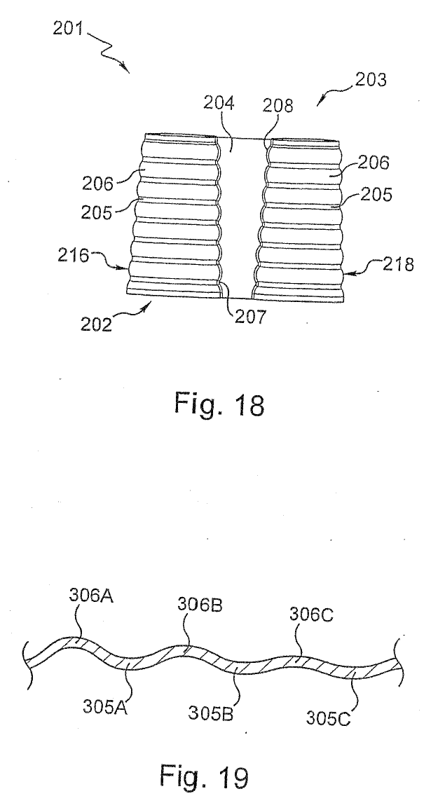

In another embodiment represented in FIG. 18 the sleeve 201 is similar to the sleeve 101 except that the tongue 104 with parallel edges is replaced by a tongue 204 with edges inclined toward each other and therefore having a trapezoidal general shape when the sleeve 201 is in its relaxed position. The tongue 204 makes good the longitudinal offset caused by the frustoconical shape of the troughs and thus facilitates two by two fitting of the bosses 206 of the trough 202 with the corresponding bosses 206 of the trough 203 and of the hollows 205 of the trough 202 with the corresponding hollows 205 of the trough 203.

In a further embodiment shown in FIG. 19 the corrugations have a varying amplitude, the distance that separates the bottom of a hollow (305A, 305B, 305C) from the top of a boss (306A, 306B, 306C) varying regularly from one corrugation to another (in a reducing manner in the example shown), also to facilitate the operation of removing the sleeve from its fabrication mold. Reducing the amplitude of the corrugations in the area of the sleeve situated in the deepest portion of the mold (the corrugation consisting of the hollow 305C and the boss 306C in the example shown) limits the risk of the sleeve impinging on the projecting portions of the mold during removal.

In variants that are not shown the ribs are attached to the wall of the troughs or result from a localized increase in thickness of the material.

In another variant not shown the flexible tongue of the sleeve has a slightly domed shape when relaxed and/or is thicker than the troughs.

In another variant the molded sleeve belongs to the PVC family.

In a further variant the sleeve is extruded in one piece in a thermoplastic material, for example polyamide or PVC.

In a further variant the two troughs are not mirror images of each other and have different dimensions from each other.

The various sleeves described are equally adapted to isolate electrically electrical components other than tags, stripped portions of electrical conductors or electrical power supply busbars, for example.

In other embodiments the sleeve is colored in order to identify and mark the cable that it surrounds, without necessarily being made from insulative material.

The present invention is not limited to the embodiments described and shown and encompasses any variant execution thereof.

1. Sleeve for electrical cables, including two troughs (2, 3; 102, 102; 202, 203) and a hinge (4; 104; 204); characterized in that each of said troughs (2, 3; 102, 103; 202, 203) is flexible in profile, extends from a first longitudinal edge (7, 8; 107, 108; 207, 208) attached to said hinge (4; 104; 204) to a free second longitudinal edge (9, 10; 109, 110; 209, 210), assumes in the absence of mechanical loading a relaxed position in which it is curved with said first longitudinal edge (7, 8; 107, 108; 207, 208) at a distance from the second longitudinal edge (9, 10; 109, 110; 209, 210) whilst it is adapted to be flexed from said relaxed position in the direction in which said distance varies; said sleeve assuming an open position in which said troughs (2, 3; 102, 103; 202, 203) are away from each other in the relaxed position, the concave surface (15, 17; 115, 117; 215, 217) of each of said troughs (2, 3; 102, 103; 202, 203) facing a space which is then empty, assuming a first stable closed position in which said space of a first of said troughs (3; 103; 203) receives the second trough (2; 102; 202) and assuming a second stable closed position in which said space of the second trough (2; 102; 202) receives the first trough (3; 103; 203), said sleeve being adapted to be deformed by bending of said hinge (4; 104; 204) and flexing in profile of said troughs (2, 3; 102, 103; 202, 203) to pass from said open position to one or the other of said stable closed positions, said first trough (3; 103; 203) flexing with said distance that increases and then decreases to receive said second trough (2; 102; 202) on passing from said open position to said first closed position, said second trough (2; 102; 202) flexing with said distance that increases and then decreases to receive said first trough (3; 103; 203) on passing from said open position to said second closed position.

2. Sleeve according to claim 1, characterized in that for each of said closed positions said troughs (2, 3; 102, 103; 202, 203) overlap over at least a quarter of the perimeter that said sleeve then has.

3. Sleeve according to claim 1, characterized in that, in said open position, said troughs (2, 3; 102, 103; 202, 203) have conformations that are mirror images of each other.

4. Sleeve according to claim 1, characterized in that each of said troughs (2, 3; 102, 103; 202, 203) has a circular arc profile in said relaxed position subtending an angle between the first longitudinal edge (7, 8; 107, 108; 207, 208) and the second longitudinal edge (9, 10; 109, 110; 209, 210) greater than 180°.

5. Sleeve according to claim 1, characterized in that each of said troughs (2, 3) has in its relaxed position a circular arc profile of the same diameter over the whole of its length.

6. Sleeve according to claim 1, characterized in that each of said troughs (102, 103; 202, 203) has in its relaxed position a circular arc profile of regularly varying diameter over the whole of its length.

7. Sleeve according to claim 1, characterized in that each of said troughs (2, 3; 102, 103; 202, 203) features a succession of ribs.

8. Sleeve according to claim 7, characterized in that each of said troughs (2, 3; 102, 103; 202, 203) is formed by a corrugated wall the corrugations whereof form said ribs.

9. Sleeve according to claim 8, characterized in that said corrugations have a constant amplitude.

10. Sleeve according to claim 8, characterized in that said corrugations have a regularly varying amplitude.

11. Sleeve according to claim 1, characterized in that said hinge is an elongate flexible tongue (4; 104; 204).

12. Sleeve according to claim 11, characterized in that said tongue (4; 104) has parallel longitudinal edges.

13. Sleeve according to claim 11, characterized in that said tongue (204) has longitudinal edges inclined toward each other.

14. Sleeve according to claim 11, characterized in that said flexible tongue (4; 104; 204) is made from the same material as said troughs (2, 3; 102, 103; 202, 203) and has a thickness different to the thickness of said troughs.

15. Sleeve according to claim 14, characterized in that said thickness of said flexible tongue (4; 104; 204) is smaller than the thickness of said troughs.

16. Sleeve according to claim 1, characterized in that it is made from an electrically insulative material.

17. Sleeve according to claim 16, characterized in that said material is a molded thermoplastic material.

18. Sleeve according to claim 16, characterized in that said material is a extruded thermoplastic material.

19. Sleeve according to claim 17, characterized in that said thermal plastic material is a polyamide.

20. Sleeve according to claim 17, characterized in that said thermal plastic material is a PVC.
